(19) United States
(12) Patent Application Publication
(10) Pub. No.: US 2013/0024514 A1
(43) Pub. Date: Jan. 24, 2013

(54) METHOD AND SYSTEM FOR CREATING ONLINE CONNECTIVITY AMONG BUSINESSES AND INDIVIDUALS WHILE PRESERVING AN INDIVIDUAL'S ANONYMITY

(71) Applicant: Jeffrey M. FELDHAHN, Atlanta, GA (US)

(72) Inventor: Jeffrey M. FELDHAHN, Atlanta, GA (US)

(21) Appl. No.: 13/552,318

(22) Filed: Jul. 18, 2012

Related U.S. Application Data
(60) Provisional application No. 61/509,629, filed on Jul. 20, 2011.

(51) Int. Cl. G06F 15/16

(52) U.S. Cl. 709/204

(57) ABSTRACT

A method of establishing a digital relationship between an individual and a provider includes providing the individual with the ability to establish a digital account on a server that will include a repository of digital content created by one or more providers that has been requested by the individual. The provider can also establish a digital account on the server that will store content of the provider to be accessed by the individual and permit the provider to establish a unique URL for embedding in web content on the world wide web or through the use of quick release codes and bar codes. An anonymous-viewing association is created between the individual and one or more providers based on the individual's clicking on a provider's unique URL contained in the web content or through the use of quick release codes and bar codes.

This application claims priority under 354 USC 119(e) based on provisional application No. 61/509,629, filed on Jul. 20, 2011

### FIELD OF THE INVENTTION

The present invention provides a method and system to enable businesses and organizations to establish a digital connection with individuals who desire to receive digital communications from the business or organization while preserving the anonymity of the individual, so that the individual need not provide to the business or organization any identifying information about themselves such as an email address, physical street address or phone number. Further, the invention provides a new method and system for establishing the effectiveness of digital advertising and obligating a business or organization to only pay for advertising within the system upon the establishment of a digital connection with individuals who desire to receive digital communications from the business or organization.

### BACKGROUND ART

The current models that exist for businesses and organizations to communicate directly to self-identified individuals who are interested in receiving information from businesses or organizations involve various mediums. The three most prevalent mediums require a recipient to possess (i) a physical address, such as a street address or post office box, (ii) a telephone or fax number, or (iii) an email address.

The oldest of these mediums involves the delivery of communications through some type of delivery service such as the United States Postal Service to a specific physical address such as a street address or post office box. Another medium involves the delivery of communications through some type of telephonic device, either wireless or landline, utilizing a telephone number to deliver a spoken message of a text message via SMS (short message service). This same medium can also involve the delivery of printed communications via a fax machine utilizing a fax number. The third principal medium involves the use of the Internet utilizing email whereby a communication can be sent to an individual's email address, or through various web tracking technologies whereby communications can be targeted to an individual based on surveillance of the individual's actions or locations visited while using the Internet.

Problems arise with each of these methods when an individual who desires to receive communications from specific businesses or organizations does not wish to provide the businesses or organizations with personally identifiable information such as a physical address, phone number, fax number or email address. And in the case of the Internet, does not wish to have web tracking technologies provide surveillance of their actions or locations on the Internet of where they have visited, in order for businesses or organizations to feed “targeted” advertising displays to them.

Under each of the mentioned methods of communication, there does not exist a system for a business or organization to deliver communications to a self-identified interested individual to receive communications from a business or organization without possessing information identifying the individual (through a physical address or email address; telephone number or fax number; or web tracking surveillance technology). Other than in the case of web tracking surveillance technologies, businesses and organizations generally acquire information that identifies individuals to whom they can deliver communications in the future through the voluntary submission of such information by the individual (through registering or “signing up” or engaging in a transaction with the business or organization) on a web page for the business or organization.

However, many individuals refuse to share their personal information, especially email addresses, with businesses and organizations because they (i) don't trust the business or organization to keep their information private (such as not selling or renting the email address to unrelated third parties) or (ii) they don't want to receive numerous, ongoing emails into their email inboxes. And for many businesses or organizations, this reticence on the part of otherwise interested individuals to share their email addresses prevents an ongoing customer relationship from developing and results in the loss of potential revenue. Further compounding the problems for businesses is the distrust individuals feel toward a business or organization that utilize web tracking surveillance technologies. And with the growing distrust of web tracking technologies there is a push on the part of government entities to strictly regulate or prohibit businesses from utilizing web tracking technologies unless an individual has affirmatively authorized such tracking technologies to be used on them.

As alluded to above, another approach through which a business or organization can acquire information on individuals is by purchasing that information from another organization in the form of the mailing list or database of that organization's customers and members. This method runs the risk of creating significant distrust between the individual and the organization selling or renting the mailing list and the organization acquiring that list.

An approach for communicating business or commercial opportunities between specific vendors wishing to promote specific purchasing opportunities to a large group of potential purchasers is the solution adopted by businesses offering “daily deals” via email to a subscriber list. These companies, Groupon and Living Social being the most recognizable companies utilizing this business model, are often referred to as “Daily Deal Companies.” Under this approach, an individual “registers for” or “subscribes to” the service provided by the Daily Deal Company and provides an email address to the Daily Deal Company where they can send an email with an offer to purchase a product or service at some reduced price from a vendor selected by the Daily Deal Company. While the individual (subscriber to the Daily Deal Company) might remain anonymous with respect to the vendor providing the offer to purchase a product or service at some reduced price, the individual had to provide information identifying them to the Daily Deal Company. And further, the individual does not control what vendors they will receive information from through the email distributed by the Daily Deal Company.

Accordingly, a need exists for individuals on the one hand and for businesses and organizations on the other hand to facilitate ongoing communications between them that doesn't require individuals desiring to obtain certain information from specific businesses or organizations to provide any personal information to the businesses or organizations in order to receive communications from them; and removes the significant barrier preventing businesses and organizations from communicating with interested individuals through a “sign up” process. For both the individual and businesses or organizations, the present invention solves this need by providing a repository for any communications requested by an individual from any business or organization, with the repository requiring no personally identifiable information on the individual so that the individual can retain total anonymity from all parties, including the provider of such repository service.

In addition to the need to facilitate ongoing communications (‘advertising”) between businesses and individuals who desire to receive such communications, a need exists to alter the economic model surrounding advertising cost structures and permitting a business to be obligated to pay for its advertising when a relationship has been established between the business and an individual who desires to receive such communications.

In each of the mediums described above, businesses are required to pay for communications (“advertising messages”) being distributed to or viewed by an individual, regardless of whether the individual desires to view such communications or not. Even in the case of certain digital communications where a business is only required to pay upon some action of the recipient of the communication, such as clicking on the advertisement or some other type of hyperlink, the action on the part of the recipient does not guarantee that the recipient wishes to or will enter into an ongoing relationship with the business that will permit the business to deliver future communications to the recipient.

Accordingly, there is needed a more effective economic model for businesses to only pay for digital communications (“advertising messages”) when a relationship connection has been created between the business and individuals who authorize the delivery of the advertising messages to themselves.

### SUMMARY OF THE INVENTION

The present invention provides a method and system that enables an individual to connect to a business or organization from whom they wish to receive regular digital communications without requiring the individual to provide to the business or organization supplying the digital communications any personally identifiable information, such as an email address in order to receive those regular digital communications.

Aspects of the invention include: (i) a step initiating the process whereby an individual is provided the ability to complete a web based registration form containing a username and password unique to the individual (the “Creator”); (ii) a further step whereby the Creator's registration information is saved and stored on a central server, and a globally unique ID is generated for the Creator; (iii) a further step whereby the Creator's globally unique ID is associated with a repository (called an iLocker) unique to that creator that permits the deposit of requested communications from various sources (“Providers”) into the Creator's iLocker; (iv) a further step whereby the creator's iLocker is displayed as a web page that is accessible through a web browser or through an application on a mobile device; (iv) a further step involving a Provider being enabled to complete a web based registration form containing a username and password unique to the Provider; (v) a further step whereby the Provider's registration information is saved and stored on a central server, and a globally unique ID is generated for the Provider; (vi) a further step permitting the Provider to access its unique account and using an HTML content editor embedded within the system associated with their unique account to create web pages of its content (“iPages”) that can be deposited within the iLocker of any requesting creator; (vii) a further step whereby a Provider is permitted to export a unique URL for its iPages with the URL being able to be embedded into any web page, quick release code (QR code), bar code or email in order to enable an individual (a Creator) to click the URL and request that the Provider's iPages go into the Creator's iLocker and creates an association with this Provider; and (viii) a further step whereby this association provides that any future iPages created by the Provider will be automatically deposited in the Creator's iLocker, unless the Creator later identifies that they no longer wish to be associated with the Provider and receive the Provider's iPages.

One advantage of the present invention is that a Creator is enabled to receive information only from those businesses or organizations that he wishes to receive communications, and the Creator is able to remain anonymous during the process. For the business or organization they are now able to send communications to individuals with whom they previously would not have been permitted to communicate: individuals unwilling to share personal information, specifically their email address, with the business or organization.

### BRIEF DESCRIPTION OF THE DRAWINGS

Reference is now made to the drawings of the invention wherein:

FIG. 1 is a flowchart showing the sequence of events for the invention for a first time user of the invention.

FIG. 2 is a flowchart showing the sequence of events for a Provider utilizing the invention and encountering an individual also utilizing the invention.

FIG. 3 shows a screen shot depicting a typical web site with a banner advertisement for a typical Provider as viewed through a web browser.

FIG. 4 shows a screen shot depicting a typical web page that an individual might encounter via clicking on the banner advertisement displayed in FIG. 3. The web page shown in this FIG. 4 is utilizing the invention by embedding a hyperlink into the web page that will establish the anonymous association between the individual and the Provider upon the individual's clicking of the hyperlink.

FIG. 5 shows a screen shot depicting a typical in-store display utilizing the invention by embedding a Provider's globally unique ID within a QR code that will establish the anonymous association between the individual and the Provider upon the individual using a mobile device to scan the QR Code.

FIG. 6 shows a screen shot depicting how the typical default view of the iLocker would look when accessed by an individual via a web browser, where the Provider described in FIGS. 3, 4 and 5 has been added to the individual's iLocker through the individual's clicking on of the embedded hyperlink shown in FIG. 4 or scanning the QR code in FIG. 5, thereby creating the anonymous association in the iLocker between the individual and the Provider.

FIG. 7 shows a screen shot of an example of typical web page content developed by a Provider (an “iPage”). This iPage is displayed to the Creator within the Creator's iLocker for any Provider with whom the individual has created an association in their iLocker and when the individual clicks on the Provider's logo or other hyperlink material within the iLocker.

### DESCRIPTION OF THE PREFERRED EMBODIMENTS

The present invention provides a method and system to enable businesses and organizations to establish a digital connection with individuals who desire to receive digital communications from that business or organization while preserving the anonymity of the individual, so that the individual need not provide to the business or organization any identifying information about themselves such as an email address, physical street address or phone number.

To accomplish this aspect of the invention, an individual (referred to herein as a “Creator”) and a business or organization (referred to herein as a “Provider”) must each opt into a web-based network of users that will establish the voluntary connections between Creators and Providers while providing anonymity to Creators with respect to Providers.

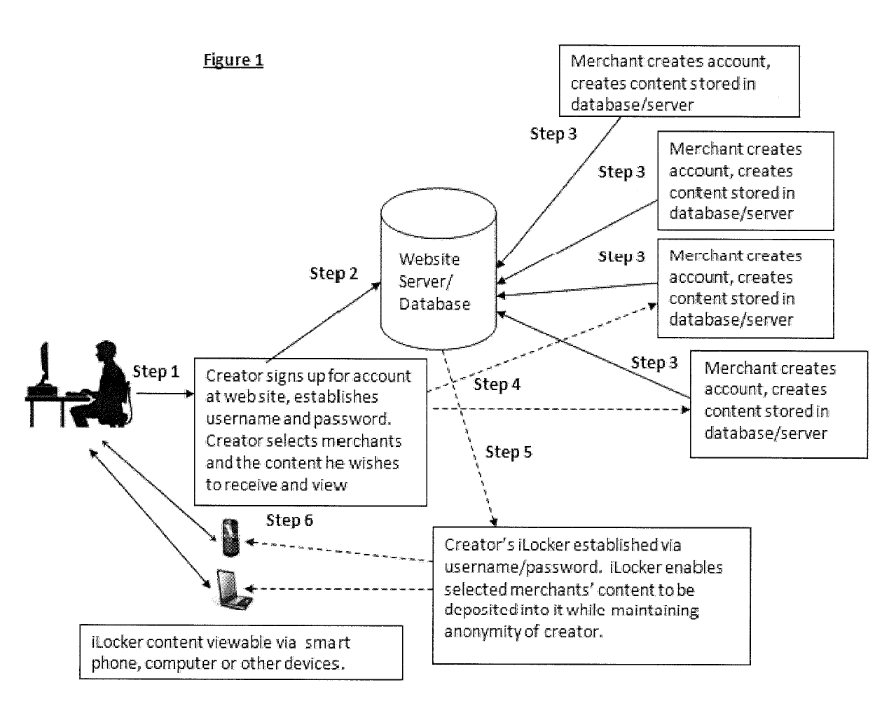

FIG. 1 details the procedure, which involves the creation of the iLocker account and the population of that iLocker with requested content from Providers.

Step 1 of FIG. 1 relates to enabling the individual (“Creator”) to access the web site and establish an iLocker account.

Step 2 of FIG. 1 relates to establishing an iLocker for the Creator with the Creator establishing a unique username and password for the iLocker account, with that username and password being stored in the database server for the web site.

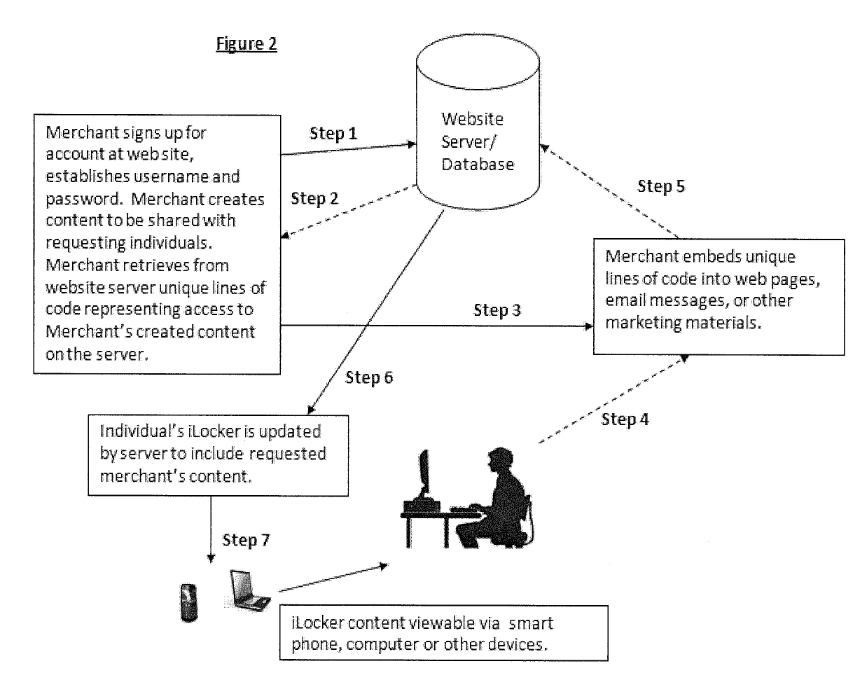

Step 3 of FIG. 1 addresses the creation of a merchant (“Provider”) account with the web site and the creation and storage of content by the Provider. Step 3 of FIG. 1 is more fully described in FIG. 2.

Step 4 of FIG. 1 involves the Creator encountering a Provider's digital content via an advertisement, web page, QR code, email or other digital format which digital content contains an embedded link, which upon the Creator to click on it a connection is established between the Creator and the Provider. The connection creates an association between the Provider and the Creator in the web site database. The association is unidirectional in that it permits the Creator to obtain content created by the selected Provider and stored in the database server of the web site, but protects the anonymity of the Creator during this transmission of content.

Step 5 of FIG. 1 involves the transmission of content created by the selected Provider and stored in the database server of the web site into the iLocker of the requesting Creator.

Step 6 of FIG. 1 involves the Creator accessing the content created by the selected Provider through the Creator's iLocker via a computer, mobile phone or other digital device.

FIG. 2 details the procedure, which involves (i) the creation of the Provider's content creation account, (ii) the creation of content by the Provider, (iii) a unique identification mechanism that enables the establishment of a connection between a Creator and the Provider and the Provider's content, and (iv) the delivery of the Provider's content to the requesting Creator who remains anonymous to the Provider.

Step 1 of FIG. 2 relates to enabling the Provider to establish a Provider account, through the creation of a username and password. The Provider is then permitted to utilize a set of web page development tools to create web content unique to the Provider with such web content stored in the web site server. The web development tools and system would not enable a Provider to embed any tracking technologies or other technologies that would generate tracking information on individuals viewing a Provider's content stored on the web site server and thereby preserve the privacy of the individual within the system.

Step 2 of FIG. 2 relates to the Provider exporting from its account a file containing certain lines of code (a unique URL that relates to the Provider's unique content stored on the web site server and a component that creates an association between the Provider and an individual clicking on the unique URL).

Step 3 of FIG. 2 relates to the Provider embedding those lines of code (the unique URL) into web pages, email marketing messages or other digital marketing materials.

Step 4 of FIG. 2 relates to an individual (a Creator) and clicking on the Provider's embedded URL that relates to the Provider's unique URL.

Step 5 of FIG. 2 relates to the web site's software platform establishing an ongoing association between the Provider and the Creator without identifying who the Creator is to the Provider.

Step 6 of FIG. 2 relates to the web site server displaying the Provider's web content to the Creator in the Creator's iLocker.

Step 7 of FIG. 2 relates to the Creator accessing the content created by the selected Provider through the Creator's iLocker via a computer, mobile phone or other digital device.

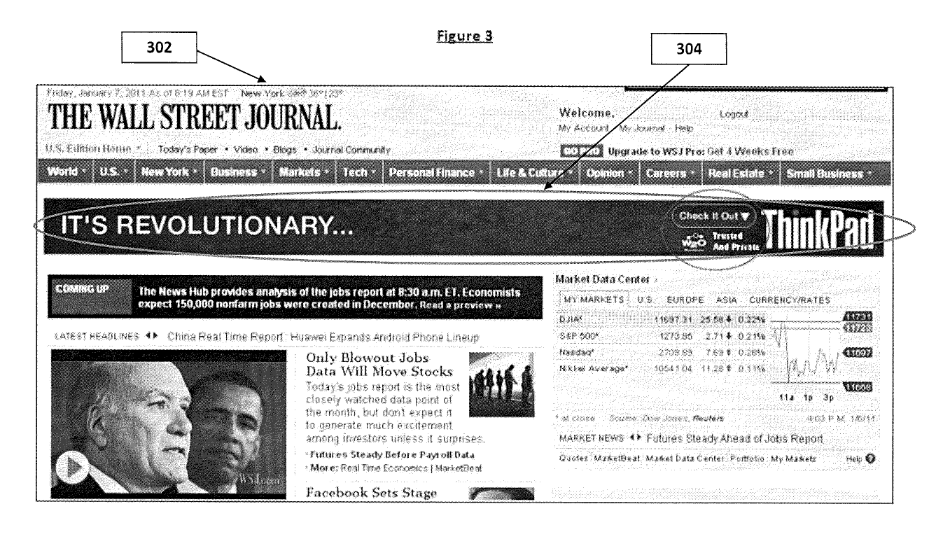

FIG. 3 shows a screen shot depicting a typical web site 302 with a banner advertisement 304 for a typical Provider as viewed through a web browser.

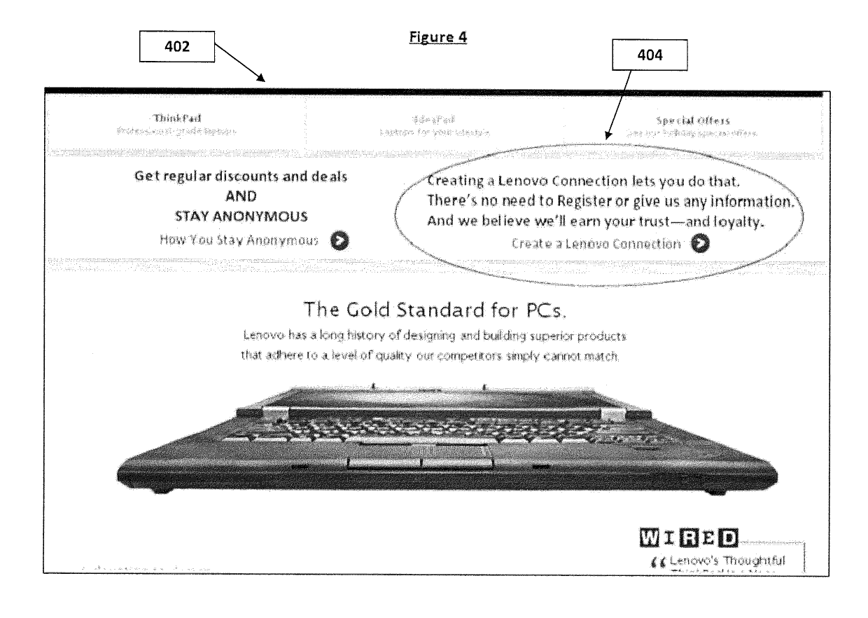

FIG. 4 shows a screen shot of a typical web page 402 that an individual might encounter via clicking on the banner advertisement 304 displayed in FIG. 3. The web page shown in this FIG. 4 is utilizing the invention by embedding a hyperlink 404 into the web page 402 that will establish the anonymous association between the individual and the Provider upon the individual's clicking of the hyperlink 404.

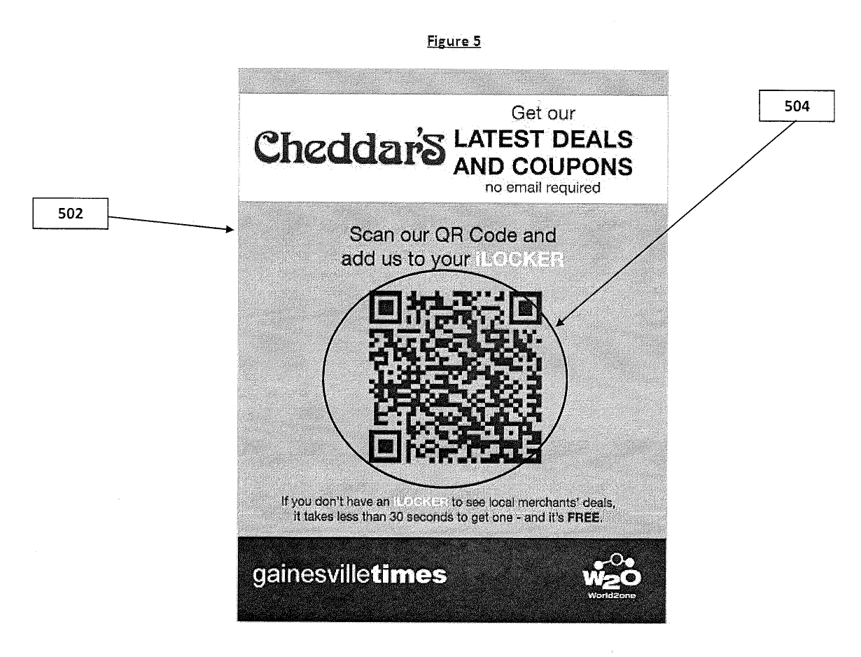

FIG. 5 shows a screen shot depicting a typical in-store display 502 utilizing the invention by embedding a Provider's globally unique ID within a QR code 504 that will establish the anonymous association between the individual and the Provider upon the individual using a mobile device to scan the QR Code.

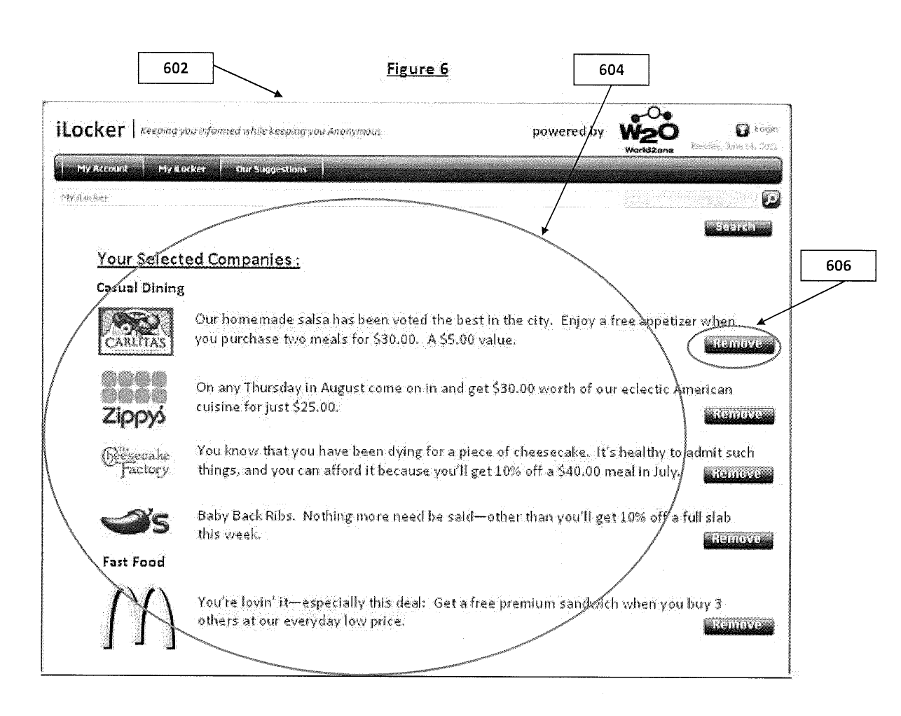

FIG. 6 shows a typical view of a Creator's iLocker 602 that contains a summary listing 604 of the various Providers with whom they have associated in their iLocker. The Creator can click on any Provider's summary description to see expanded content of the Provider displayed on the iPage shown in FIG. 6. The iLocker also displays remove buttons 606 which allow the creator to terminate the relationship with a given Provider. When the remove button is clicked, the Provider's summary listing will no longer appear in the Creator's iLocker.

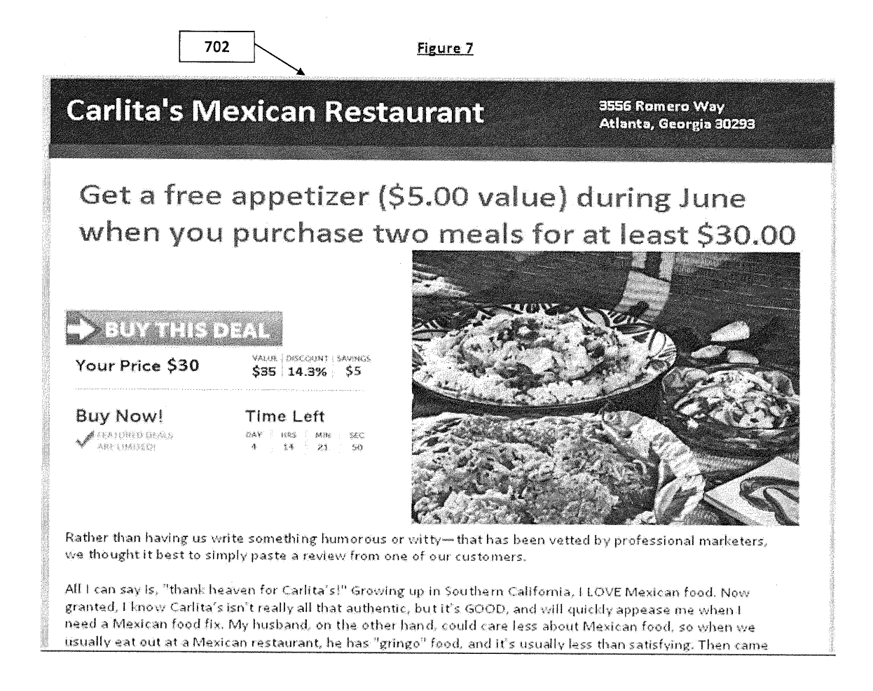

FIG. 7 shows a screen shot of an example of typical web page content developed by a Provider (an iPage). This iPage is displayed to the Creator within the Creator's iLocker 702 for a Provider with whom the individual has created an association in their iLocker and when the individual clicks on the Provider's logo or other hyperlink material within the iLocker.

What is claimed:

1. A method of establishing a digital relationship between a creator and a provider whereby the creator is anonymous to the provider, yet the provider is able to deliver and display web content to the creator, comprising the steps of:
providing the creator with the ability to establish a digital account on a server that will include a repository of digital content created by providers that has been requested by the creator from the providers;
providing the provider with the ability to establish a digital account on the server that will store content of the provider to be accessed by the creator and to establish a unique URL for embedding in web content on the world wide web or in a quick release code or bar code,
creating an association on the server between the creator and selected providers upon the creator's clicking on a provider's unique URL contained in the web content or in a quick release code or bar code, the association allowing digital content of the selected provider stored in the repository to be anonymously viewed by the creator, the anonymous viewing meaning that the provider does not know the identity of the creator but the provider can still supply content to the repository for anonymous viewing as long as the association is not ended.

2. The method of claim 1, wherein the association can be between a creator and a number of providers.

3. The method of claim 1, wherein the server provides web content development tools for creating web content unique to the provider, the web development tools preventing any tracking information to be associated with the provider's unique URL.

4. The method of claim 1, wherein the content of the provider stored on the server is a coupon for services, goods, a discount on services or goods or information the provider desires the creator to view.

5. The method of claim 1, wherein the creating step provides an ability for the Creator to terminate the association with the provider so that no further digital content of the provider is supplied to the repository of the creator terminating the association.

6. A system comprising a server, the server including a computer program in the form of non transitory media that is capable of practicing the method of claim 1.

7. A computer readable media in the form of non-transitory media that stores a computer program, the computer program capable of practicing the method of claim 1.
